(19) United States
(12) Patent Application Publication
(10) Pub. No.: US 2015/0350478 A1
(43) Pub. Date: Dec. 3, 2015

(54) METHOD AND APPARATUS FOR CONTROLLING A BACKLIGHT IN A DISPLAY UNIT OF AN IMAGE PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventors: Makoto HIBINO, Kannami (JP); Saravanacoumar DOURECANNOU, T.R. Pattinam (IN)

(73) Assignees: KABUSHIKI KAISHA TOSHIBA, Tokyo (JP); TOSHIBA TEC KABUSHIKI KAISHA, Tokyo (JP)

(21) Appl. No.: 14/293,913

(22) Filed: Jun. 2, 2014

(51) Int. Cl. H04N 1/00

(52) U.S. Cl. CPC H04N 1/00904; H04N 2201/0094

(57) ABSTRACT

An image processing apparatus according to an embodiment includes a print unit that prints an image on a recording medium based on scan print data generated by reading an image from a document or remote print data received from an information terminal connected to a network. A control panel with a display unit receives input from a user. The display unit includes a backlight. A control unit controls the backlight to be on when the control panel is accepting input from the user indicating a start of scanning to generate the scan print data, and controls the backlight to be off when performing printing of the remote print data.

### FIELD

Embodiments described herein relate generally to an image processing apparatus which may be accessed from the outside.

### BACKGROUND

In the related art, a multi-function peripheral (MFP) including a control panel with a display unit is connected to an information terminal via a network. The MFP may turn off the backlight of the display unit in a power-saving mode and thus suppress power consumption.

However, when receiving a printer job, for example, the MFP transitions to a normal mode and also turns on the backlight of the display unit. In other words, when the MFP transitions from a power-saving mode to a normal mode, the control panel of the MFP is also started simultaneously. Therefore, there is a problem that, even when the control panel of the MFP is not operated, the control panel is turned on and causes power consumption.

### DESCRIPTION OF THE DRAWINGS

FIG. 1 is a schematic diagram of an image processing apparatus.

FIG. 2 is a flowchart describing a power-saving mode processing for a scan operation, according to an embodiment.

FIG. 3 is a flowchart describing a power-saving mode processing for a remote printing operation, according to the embodiment.

FIG. 4 is a diagram schematically showing a power-saving mode processing and a normal mode processing, according to the embodiment.

FIG. 5 is a flowchart describing a transition from a normal mode to a power-saving mode, according to the embodiment.

### DETAILED DESCRIPTION

An image processing apparatus according to an embodiment includes a print unit that prints an image on a recording medium based on scan print data generated by reading an image from a document or remote print data received from an information terminal connected to a network. A control panel with a display unit receives input from a user. The display unit includes a backlight. A control unit controls the backlight to be on when the control panel is accepting input from the user indicating a start of scanning to generate the scan print data, and controls the backlight to be off when performing printing of the remote print data.

Hereinafter, an exemplary embodiment will be described in detail with reference to the drawings.

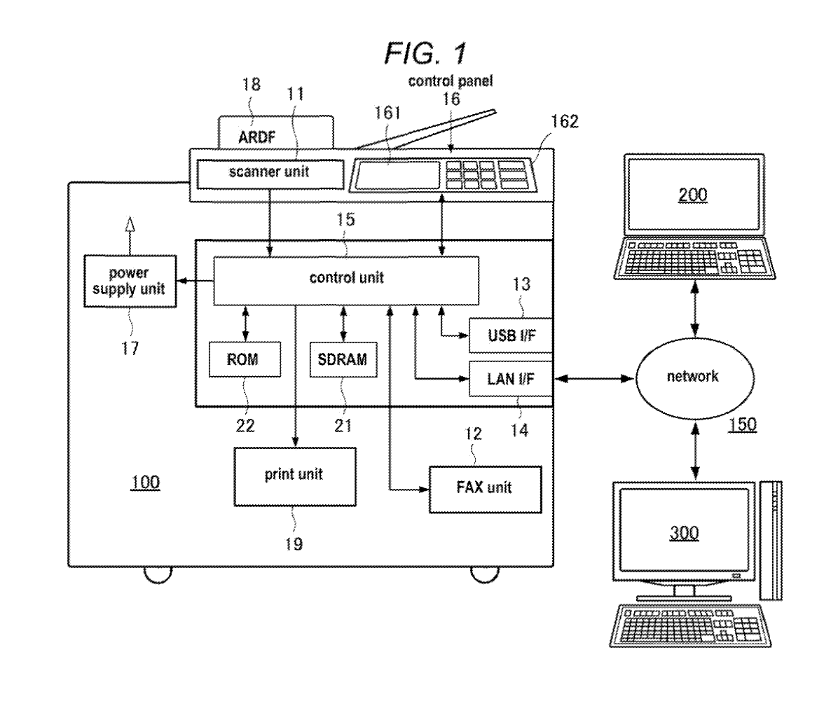

FIG. 1 is a schematic diagram of an image processing apparatus.

In the embodiment, an MFP 100 is an image processing apparatus. The MFP 100 is an all-in-one type peripheral having a plurality of functions such as copy, scan, FAX, in addition to a printer function.

As illustrated in FIG. 1, the MFP 100 is connected to personal computers (PC) 200 and 300, which are information terminals, via a network 150. The MFP 100 includes a scanner unit 11, a FAX unit 12, a USB interface 13, and a LAN interface 14, which perform print data input function. The MFP 100 also includes a print unit 19 which performs print data output functions.

In addition, the MFP 100 includes a control unit 15 which controls the print data input and output functions. Further, the MFP 100 includes a control panel 16 which performs a user interface function and a power supply unit 17 which performs a power function. The power supply unit 17 generates a power for the entire MFP 100 and includes a power-saving function which reduces power consumption based on the control of the control unit 15. The MFP 100 includes an auto reverse document feeder (ARDF) 18 and a print unit 19 which perform a sheet feeding and ejecting function.

The scanner unit 11 is disposed below a translucent document tray (not illustrated), and can freely move back and forth in a sub-scanning direction for scanning functions. The scanner unit 11 includes a lamp which irradiates a document placed on the document tray, a mirror which deflects light reflected from the document, a CCD as a phototransistor which receives an optical image from the mirror, a motor for moving and scanning and the like. The scanner unit 11 moves in a sub-scanning direction (a direction perpendicular to the sheet) so as to read an optical image of the document on the document tray. The read optical image is transitioned by the CCD, subjected to a predetermined processing in an image processing unit (not illustrated) and then output to the control unit 15 as print data.

The FAX unit 12 is capable of transmitting and receiving FAX data to and from the outside and is connected to the control unit 15 for exchanging print data.

The USB interface 13 is capable of being connected to various electronic devices embedded with a USB connector and of transmitting and receiving a data to and from the control unit 15.

The LAN interface 14 is capable of exchanging print data and the like to external devices, such as the PC 200 and the PC 300, via the network 150.

As the control unit 15, a Central Processing Unit (CPU) or a Micro Processing Unit (MPU) capable of performing computing processing may be used. In addition, part or ail of the functions of the MFP 100 may be realized in an Application Specific Integrated Circuit (ASIC) as a processor.

The control panel 16 includes a display unit 161 with a backlight which displays a setting screen, a state of the apparatus or the like, and an operation unit 162 for operating the MFP 100 and the like. In addition, the display unit 161 may foe a touch-panel type display, and may display functions of the operation unit 162 on the touch-panel.

The print unit 19 forms an image using an electrographic method. The print unit 19 scan-exposes a photoreceptor using a light beam emitted from a laser light source, which is subjected to light-on control using print data processed for image formation, and generates an electrostatic latent image. Then, the print unit 19 develops the generated electrostatic latent image using a toner, and transfers the created toner image to a sheet which is a recording medium. Subsequently, the sheet to which the toner image is transferred is caused to pass through a fixing unit heated by a fixing heater, thereby fixing the toner image on the sheet. Thereafter, when a post-processing is instructed, the post-processing is done to perform a print output.

Although the description is given on the print unit 19 using a laser method, the print unit 19 may use an ink jet method or the like.

The control unit 15 is connected to the scanner unit 11, the FAX unit 12, the LAN interface 14, the USB interface 13, the print unit 19 and the control panel 16, respectively, so as to be capable of print data communication. In addition, writing and deleting of a data is possible inside the control unit 15.

The control unit 15 includes a flash Read Only Memory (ROM) 21 and a Synchronous Dynamic Random. Access Memory (SDRAM) 22 (which has an operation speed faster than that of the flash ROM 21).

The flash ROM 21 stores a program, which realizes a function of performing an image processing using a plurality of applications, or setting values relating to the apparatus.

The SDRAM 22 temporarily stores a data computed by the control unit 15, or print data.

The control unit 15 controls the print unit 19 to be in a normal mode when a print operation is performed from the control panel 16, and prints and outputs print data input to the control unit 15. In addition, the control unit 15 causes the power supply unit 17 of the digital multi-function peripheral 100 to transition between a ready mode, a normal mode and a power-saving mode.

The ready mode is a mode in which the control panel 16 is operated, power is input from the power supply unit 17 to the print unit 19 or the like which is required for printing, and preparation for printing is completed.

The normal mode is a mode in which, for example, the temperature of the fixing roller is maintained at a temperature appropriate for fixing of a developer such as a toner and printing is immediately possible when a print request is received. In this case, since it is necessary for the temperature of the fixing roller to be maintained at a temperature appropriate for fixing of the developer, power consumption is large.

The power-saving mode is, for example, a mode in which the temperature of the fixing roller is maintained higher than room temperature taut lower than that in the normal mode, printing is not immediately possible upon a print request and it takes a certain period of time until the fixing roller is heated to reach an appropriate temperature for printing. In this case, since the temperature of the fixing roller may be maintained low, power consumption may be smaller than that in the normal mode.

In. the normal mode, when the control panel 16 is operated, the backlight of the display en it 161 is turned on. When a copy operation is performed, the document is immediately scanned by the scanner unit and the data read from the document is printed. When there is no operation within a predetermined time after the operation of the control panel 16, the normal mode transitions to the power-saving mode and power consumption is suppressed.

The control unit 1.5 monitors the state of the MFP 100 and, when a predetermined condition is met, transitions the power supply state to the power-saving mode. The predetermined condition is, for example, a condition in which a certain period of time elapses after a job such as performing printing and standing by.

When a print request is received via the network 150, the MFP 100 transitions from the power-saving mode to the normal mode, performs printing and ejects a printed sheet. In this case, the control panel 16 in the normal mode does not turn on the backlight. In addition, when there is no request from the outside to the LAN interface 14 and a certain period of time elapses after the previous communication, the MFP 100 transitions from the normal mode to the power-saving mode.

When printing in the normal mode by a remote operation, the backlight of the control panel 16 is turned off. However, in an event of a sheet jam, an event of no sheet or the like occurs, the backlight is turned on, i.e., changed from a light-off state, even when printing in the normal mode by a remote operation. Also, in such a case, the MFP 100 notifies the event information to the user.

In this manner, after a transition time elapses in a state where there is no print processing to be performed, the MFP 100 is automatically transitioned to the power-saving mode. The transition time is a time to be taken until the mode is automatically transitioned to the power-saving mode by the control of the control unit 15 when the MFP 100 satisfies the predetermined condition during the transition time thereof. The transition time is set by a manager or the like, or preset as a specification for each MFP 100.

The transition time may be set different for a case of operation from, the control panel 16 and for a case of operation from the PC 200 or PC 300. The transition times corresponding to the operation of the control panel 16 and the PC 200 or PC 300 are stored as setting values in the flash ROM 21, for example.

In addition, the control unit 15 starts the print unit 19 in response to a print request from the PC 200 and the PC 300 (which are connected to the network 150 and the LAN interface 14), and performs printing.

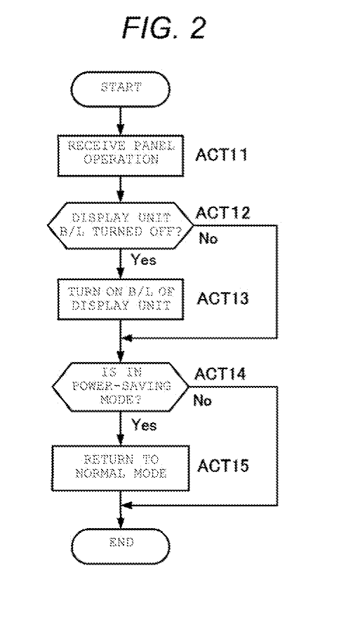

Hereinafter, a power-saving mode processing of an exemplary embodiment will be described with reference to FIGS. 2 to 5.

FIG. 2 illustrates a flowchart when a scan is performed by an operation of the control panel 16 of the MFP 100.

The control unit 15 receives a panel operation when an operation such as pressing of a scan button (not illustrated), for example, from the control panel 16 of the MFP 100 is performed (ACT11).

The control unit 15 determines whether the display unit 161. of the MFP 100 is in a light-off state or not (ACT12).

In ACT12, when the display unit 161 is determined to be in a light-off state (Yes), the backlight of the display unit 161 is turned on (ACT13) and the process proceeds to ACT14. In ACT12, when the display unit 161 is determined to be in a light-on state (No), the process proceeds to ACT14.

In ACT14, it is determined whether the MFP 100 is in the power-saving mode or not. In ACT14, when the MFP 100 is in the power-saving mode (Yes), a warm-up is started and the power-saving mode returns to the normal mode (ACT15) and the processing is performed and completed. When the MFP 100 is not in the power-saving mode (No), the processing is performed and completed.

In the flowchart of FIG. 2, in addition to mentioning the scan operation from the control panel 16, a copy, FAX transmission or the like operation may be subject to the same power-saving mode processing.

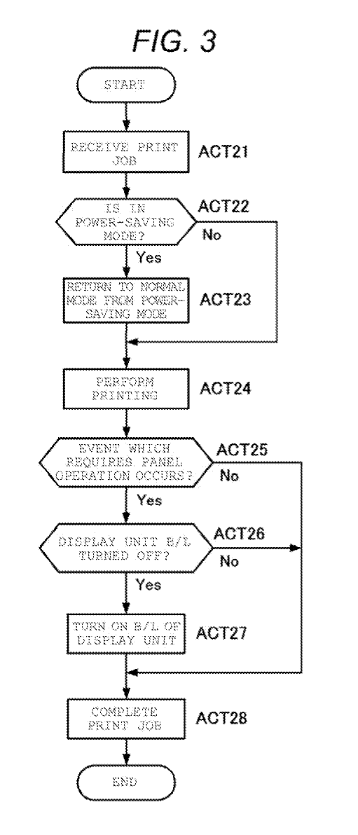

FIG. 3 illustrates a flowchart of a print processing of the MFP 100 when an operation is performed remotely via the network 150.

When there is a request for a print job f runs the PG 200, for example, via the network 150 and the LAP interface 14, the control unit 50 receives the print job (ACT21).

The control unit 50 determines whether the MFP 100 is in the power-saving mode or not (ACT22).

In ACT22, when the MFP 100 is in the power-saving mode (Yes), the process proceeds to ACT23, a warm-up is started to return the power saving mode to the normal mode, and the process proceeds to ACT24.

In ACT24, a printing is performed, and the process proceeds to ACT25.

In ACT25, it is determined whether or not there occurs an event of a sheet jam, an event of no sheet, or the like, which requires the control panel 16 to operate.

In ACT25, when it is determined that an event occurs (Yes), the process proceeds to ACT26.

In ACT26, it is determined whether or not the display unit 161 is in a light-off state. In ACT25, when, the display unit 161 is determined to be in a light-off state (Yes), the process proceeds to ACT27.

In ACT27, the light-on processing of the display unit 161 is performed, the process proceeds to ACT28 and the print job is completed.

In ACT25, when no event occurs (No), the process proceeds to ACT28. In ACT26, when the display unit 161 is in a light-on state (do), the process proceeds to ACT28. In each case, the print job is completed.

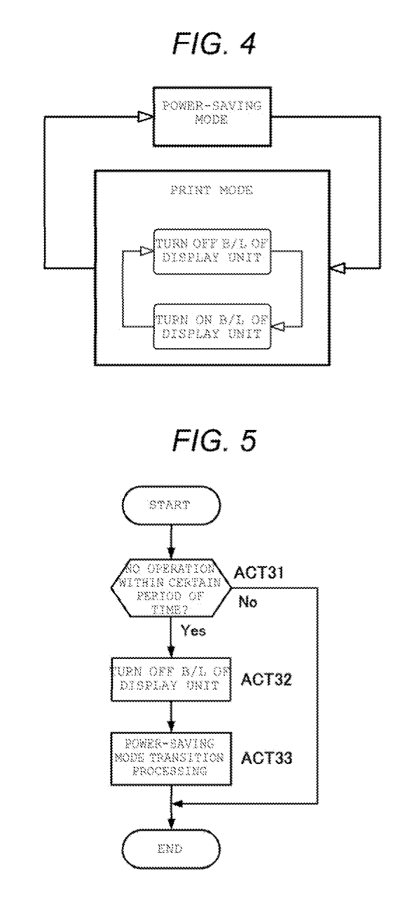

Further illustrating the flowchart of FIG. 3, FIG. 4 schematically illustrates an example of the power-saving mode processing and the normal mode processing in the MFP 100 for a remote operation via the network 150. In other words, the MFP 100 includes the power-saving mode and the normal mode. The display unit 161 is usually in a light-off state even in the normal mode and turns on the light when a special event occurs.

FIG. 5 illustrates a flowchart of a processing of the digital multi-function peripheral 100 being transitioned from the normal mode to the power-saving mode.

The control, unit 50 determines whether there is an operation of the control panel 16 within a certain period of time in the MFP 100 which is in the normal mode state due to an operation of the control panel 16 (ACT31). At this time, the display unit 161 is in a Light-on state.

In ACT31, when there is no operation of the control panel 16 after a certain period of time elapses (Yes), the process proceeds to ACT32 and the backlight of the display unit 161 is turned off.

The control unit 50 causes the MFP 100 to transition to the power-saving mode in which the temperature of the fixing roller is lowered and the like (ACT33), and completes the processing.

In addition, in ACT31, when there is an operation of the control panel 16 within a certain period of time (No), the processing operated, by the control panel 16 is performed.

In this manner, when the MFP 100 is operated, by a remote operation-except for the case in which an event of a sheet jam, an event of no sheet, or the like occurs-the backlight of the display unit 161 is in a light-off state even in the normal mode. When an event occurs, the backlight of the display unit 161 is turned on in order to notify the event information to another user who operates the control panel 16 of the main body of the MFP 100.

in this exemplary embodiment, when the MFP 100 is operated by a remote operation, the backlight of the display unit 161 is turned off even in the normal mode. Accordingly, it is possible to achieve reduced energy consumption.

In the above-described embodiment, printing in the MFP 100 is exemplified. However, the following (1) to (4) are exemplified as other application examples.

(1) An application for remote scanning is possible. The remote scan causes the MFP 100 to perform scanning when requested from an information terminal, such as a PC, when a document is placed on a scan position of the MFP 100. In this case, when the scan operation is set and performed by the request from the information terminal via a network without a direct operation of the main body of the MFP 100, the backlight of the display unit 161 of the MFP 100 is not turned on. The data after scanning is stored in a predetermined storage space according to an instruction from the information terminal.

(2) An application for Internet FAX transmission is possible. The Internet FAX transmits an image data from, an information terminal to the MFP 100 to perform Internet FAX in the MFP 100. In this case, an operation of the control panel 16 of the MFP 100 is not necessary at all. When printing a fax receipt showing the transmission result, the printing is performed without turning on the backlight of the display unit 161.

(3) An application for automatic log printing is possible. The automatic journal printing automatically prints a list of items transmitted and received when the number of items transmitted and received reaches a predetermined number. In this case, the list is printed without turning on the backlight of the display unit 161.

(4) Images stored inside the MFP 100 may be viewed using a browser such as the Internet Explorer. The images stored inside the MFP 100 may then be printed from the browser. In this case, since the printing may be performed without operating the control panel, the printing may be performed without turning on the backlight of the display unit 161.

The embodiments are not limited to the exemplary embodiments described above. For example, while the MFP 100 is being used in the normal mode by a remote operation, when an event occurs, the backlight of the display unit 161 is turned on. Even in this case, since the display unit 161 turns off the backlight until the user who uses the MFP 100 touches the control panel 16, it is possible to achieve further reduced power consumption. Instead of configuring the backlight of the display unit 161 to be turned on by touching, other configurations may be possible in which a motion sensor is included in the MFP 100 and a backlight of a display unit 161 is turned on when the motion sensor senses that the user approaches close to the MFP 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope end spirit of the inventions.

What is claimed is:

1. An image processing apparatus comprising:
a print unit configured to print an image on a recording medium based on scan print data generated by reading an image from a document or remote print data received from an information terminal connected to a network;
a control panel with a display unit configured to receive input from a user, the display unit including a backlight; and
a control unit configured to control the backlight to be on when the control panel is accepting input from the user indicating a start of scanning to generate the scan print data, and to control the backlight to be off when performing printing of the remote print data.

2. The image processing apparatus according to claim 1, wherein:
the print unit is configured to change from a normal mode in which a fixing roller is maintained at a fixing temperature to a power-saving mode is which the fixing roller is maintained at a power-saving temperature lower than the fixing temperature, and
the fixing roller is heated from the power-saving temperature to the fixing temperature when a print command is received.

3. The image processing apparatus according to claim 2, wherein the print unit transitions from the normal mode to the power-saving mode when the control panel does not receive input from a user within a certain period of time in the normal mode.

4. The image processing apparatus according to claim 3, wherein the print unit transitions from the power-saving mode to the normal mode when the control panel receives input from the user in the power-saving mode.

5. The image processing apparatus according to claim 4, wherein the control unit controls the backlight to be off when the print unit is in the normal mode unless the control panel receives input from the user in the normal mode.

6. The image processing apparatus according to claim 4, wherein the control unit controls the backlight to be off when the print unit is in the normal mode unless one of a paper jam and a no-recording-medium state occurs in the image processing apparatus.

7. The image processing apparatus according to claim 2, wherein the print unit transitions from the normal mode to the power-saving mode while the backlight is off when there is no print command received from the information terminal within a certain period of time.

8. An image processing apparatus comprising:
a control panel with a display unit configured to receive input from a user, the display unit including a backlight;
a print unit configured to print an image on a recording medium based on an input print request received as input from a user in the control panel or a remote print request received from an information terminal connected to a network, the print unit having a normal mode in which printing can be performed immediately and a power-saving mode in which power consumption is less than the normal mode; and
a control unit configured to control the backlight to be on when the control panel is accepting the input print request from the user, and to control the backlight to be off when performing printing of the remote print data.

9. The image processing apparatus according to claim 8, wherein:
the print unit is configured to change from the normal mode in which a fixing roller is maintained at a fixing temperature to the power-saving mode in which the fixing roller is maintained at a power-saving temperature lower than a fixing temperature, and
the fixing roller is heated from the power-saving temperature to the fixing temperature when a print command is received.

10. The image processing apparatus according to claim 8, further comprising:
a scanner unit configured to generate scan image data by scanning a document based on a request sent from the information terminal, wherein the control unit controls the backlight to be off when the scan image data is generated.

11. The image processing apparatus according to claim 10, wherein the control unit is further configured to perform an Internet FAX function in response to a request from the information terminal wherein the control unit controls the backlight to be off when the Internet FAX function is performed.

12. The image processing apparatus according to claim 11, wherein a transmission and reception list is automatically printed in the printing unit when a number of transmissions and receptions performed using the Internet FAX function reaches a predetermined number, and the control unit controls the backlight to be off when the transmission and reception list is printed.

13. The image processing apparatus according to claim 8, wherein the control unit controls the backlight to be off when the print unit is in the normal mode unless at least one of; a paper jam, a no-recording-medium state, and a receipt of an input from the user occurs in the image processing apparatus.

14. The image processing apparatus according to claim 8, wherein the print unit transitions from the normal mode to the power-saving mode while the backlight is off when there is no print command received from the information terminal within a certain period of time.

15. A method comprising the steps of:
receiving in an image forming apparatus one of scan print data generated by reading an image from a document and remote print data acquired from an information terminal connected to a network;
printing, with a print unit, the received one of the scan print data and the remote print data; and
controlling a backlight of a display unit in a control panel configured to receive input from a user so that the backlight is on when the control panel is receiving input from the user indicating a start of scanning to generate scan print data, and so that the backlight is off when performing printing of the remote print data.

16. The method according to claim 15, further comprising:
changing the print unit from a normal mode in which a fixing roller is maintained at a fixing temperature to a power-saving mode is which the fixing roller is maintained at a power-saving temperature lower than the fixing temperature when the control panel does not receive input from a user within a certain period of time in the normal mode, and
changing the print unit from the power-saving mode to the normal mode when a print command is received in the control panel.

17. The method according to claim 16, wherein the print unit transitions from the power-saving mode to the normal mode when the control panel receives input from the user in the power-saving mode.

18. The method according to claim 17, the backlight is controlled to be off when the print unit is in the normal mode unless the control panel receives input from the user in the normal mode.

19. The method according to claim 17, wherein the backlight is controlled to be off when the print unit is in the normal mode unless one of a paper jam and a no-recording-medium state occurs in the image processing apparatus.

20. The method according to claim 16, wherein the print unit is changed from the normal mode to the power-saving mode while the backlight is off when there is no print command received from the information terminal within a certain period of time.
